(19) United States
(12) Patent Application Publication
(10) Pub. No.: US 2006/0187544 A1
(43) Pub. Date: Aug. 24, 2006

(54) Flexible screen for front and rear projection

(76) Inventors: David Wiener, Park City, UT (US); Clayton C. Shaw, Park City, UT (US)

Correspondence Address: Gordon & Jacobson, P.C., Suite 407, 60 Long Ridge Road, Stamford, CT, 06902, US

(21) Appl. No.: 11/076,240

(22) Filed: Feb. 23, 2005

(51) Int. Cl. G03B 21/56

(52) U.S. Cl. 359/443; 359/449; 359/460

(57) ABSTRACT

A projection screen is constructed of an open mesh fabric central portion for imaging a projected image, a sturdier border, and hanging hardware at each of the corners of the border. The central portion is constructed of a knit of multiple synthetic fibers twisted together and provides a screen with high diffusion. The open mesh provides substantial transparency to the screen when no image is being projected onto the screen permitting the screen to be used in a manner in which it will not act as a significant visual barrier when installed but not in use. The screen is mounted with hanging hardware that pulls the border and central portion taut. The screen when installed and taut has high diffusion and permits both front and rear projection with substantially equal brightness at both sides of the screen.

### BACKGROUND OF THE INVENTION

1. Field of the Invention

This invention relates broadly to projection screens in the field of optics. More particularly, this invention relates to flexible projection screens made of a fabric.

2. State of the Art

Projection screens are used with a projector configured to project images on the screen to be watched by a viewer. Various projection screens have been devised in the past. However, for the most part, these have been unnecessarily bulky. Moreover, commonly, the tensing system which holds the screen taut to prevent sag extends behind the screen, limiting use of the screen for rear projection.

Many situations where rear projection is desirable are well-known. Furthermore, the inventor has realized that there are certain situations in which it would be desirable for a screen to project an image which is viewed from both the front and rear sides of the screen at the same time. By way of example, promotional, retail, sporting, and fashion events are such situations. More particularly, in a retail establishment, a screen within a display window which has images that can be seen from both within and outside the store would be beneficial. Also, at a sporting event, a large screen that can be viewed by spectators on either side of the screen but which is imaged by a single projector would be advantageous. None of the prior art screens are suitable for this purpose.

The problem with achieving this goal is several fold. First, screens that permit both front and rear projection do not provide sufficient brightness across a wide field of view at both sides of the screen. Second, prior art screens are too opaque for many applications, creating spatial divides in the spaces in which they are set up, especially when they are not in use. Third, many prior art screens can be hard to set up. A portable screen which is easily assembled would be advantageous. Fourth, prior art screens and their framing systems can be too heavy and bulky for larger applications.

### SUMMARY OF THE INVENTION

It is therefore an object of the invention to provide an improved projection screen which addresses the disadvantages of prior devices in a practical and satisfactory manner.

It is another object of the invention to provide a projection screen that has a wide field of view and high projected brightness values.

It is a further object of the invention to provide a projection screen that is substantially transparent when an image is not being projected thereon.

It is yet another object of the invention to provide a projection screen which is simple and economical to construct and install.

It is also an object of the invention to provide a screen that is lightweight and collapsible to such an extent that it can be conveniently packed for transport.

In accord with these objects, which will be discussed in more detail below, a projection screen is provided which is constructed of an open mesh fabric central portion for imaging a projected image, a sturdier or reinforced fabric border, and hanging hardware spaced apart about the border. The central portion is constructed of a knit of multiple synthetic fibers twisted together. The fibers have relatively high brightness, but low reflectivity when projected thereonto. The open mesh provides substantial transparency to the screen when no image is being projected onto the screen, thereby permitting the screen to be used in a manner in which it will not act as a significant visual barrier within the installation space when not in use, provides acoustic transparency, and permits air passage for use in windy conditions.

The screen is mounted with hooks and cables which anchor the hanging hardware and pull the border and central portion taut. The screen when installed and taut permits both front and rear projection with substantially equal brightness at both sides of the screen. It is noted that the manner of hanging the screen does not create any barrier to viewing the images on either side of the screen. In addition, according to a preferred aspect of the invention and as a result of the fabric construction, the brightness of the projected image is relatively consistent substantially 360° about the screen; i.e., 180° on each side.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic view of the projection screen of the invention;

FIG. 2 is a schematic view of one installation for rear projection on the projection screen according to the invention; and

FIG. 3 is a schematic view of one installation for front projection on the projection screen according to the invention.

### DETAILED DESCRIPTION

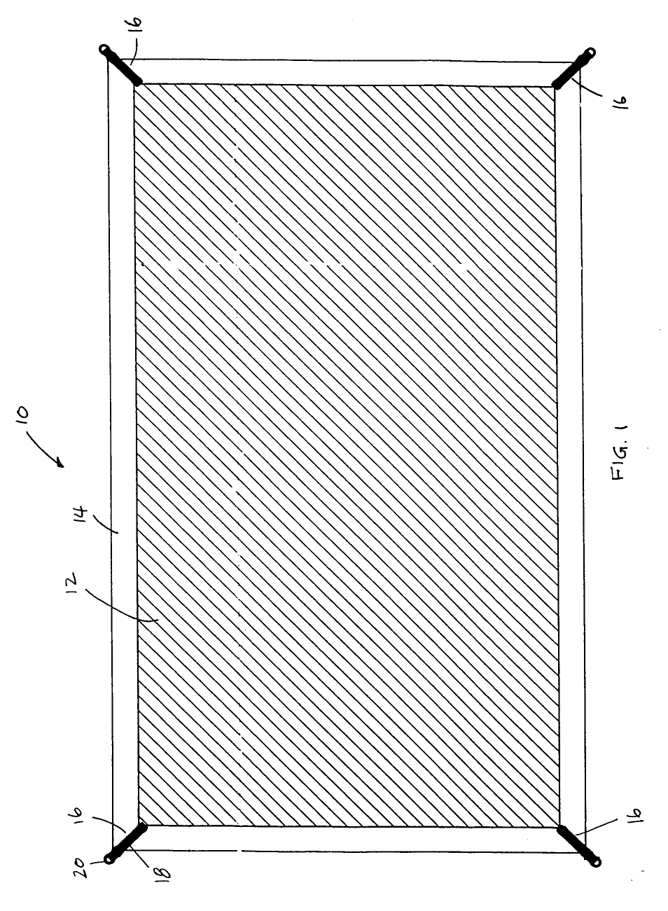

Turning now to FIG. 1, a flexible projection screen according to the invention is shown 10. The screen includes a fabric central portion 12 for imaging a projected image, a sturdier fabric border 14 about the entire periphery of the central portion, and hanging hardware 16 at each of the corners of the border. The hanging hardware 16 preferably includes reinforced webbing 18 and a D-ring 20. The screen 10 is preferably rectangular in shape, but may be in the shape of other polygons, circular, oval, or even fanciful shapes, provided the central portion 12 can be pulled taut by the hardware 16.

The central portion 12 is a knit construction, wherein two or more synthetic substantially opaque fibers are twisted or wound together as a thread and the thread is knit together into an open mesh. The fibers are preferably spun polyester in a substantially white color with low to moderate reflectivity, and the thread is preferably approximately 0.3 mm in diameter. The mesh is knit with round holes, which have been found to have increased image detail over square, triangular or zig-zag shaped holes. The round hole preferably has a diameter of approximately 0.65 mm. The twisted fiber center-center dimension across the hole is approximately 1.2 mm. It is believed that each of these characteristics contributes to the very high diffusion, uniform brightness across a wide field of view, and excellent rear projection qualities of the screen. One currently available and suitable mesh fabric having these characteristics (with two fibers twisted together) is available as mosquito netting #FMN008 from American Home and Habitat Inc. of Squires, Mo. American Home and Habitat Inc. provides the mesh fabric as a barrier against winged insects and has not taught or suggested the use of the fabric for a projection screen.

The open mesh central portion 12 is substantially transparent when no image is being projected onto the screen permitting the screen to be used in a manner in which it will not act as a significant visual barrier when the screen is installed but not in use. The central portion is also acoustically transparent, permitting live music and/or audio speakers to be positioned behind the screen without detrimental acoustic effect.

The border 14 is preferably constructed of either a stretch fabric, such as a neoprene, or a non-stretch fabric, such as ballistic nylon. Other materials, both fabric and non-fabric, may be also be used.

The fabric construction of the entire screen is relatively durable. In fact, the screen, unlike conventional screens, is machine washable should it become soiled. Furthermore, the screen is weatherproof and can be used outdoors in substantially all weather conditions. In addition, the open mesh construction of the central portion permits air flow through the screen permitting the screen to be used outdoors during windy conditions. During transportation, the screen may be folded, rolled, or even crumpled into a compact shape. Then, upon mounting, as the screen is pulled taut the wrinkles are eliminated.

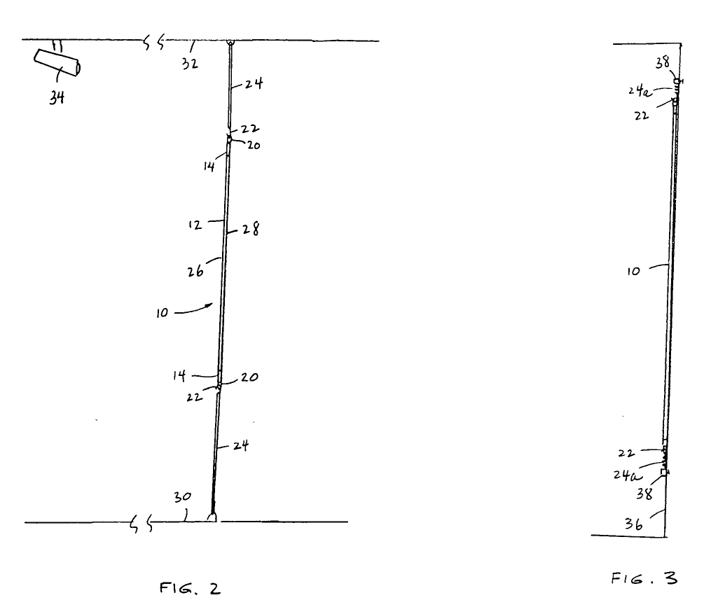

The screen 10 is mounted to a static structure (e.g., floor and ceiling 30, 32) with hooks 22 and/or suspenders 24 (including cables, bungee cords, natural and synthetic resilient and non-resilient cords, fabric ties, springs, etc.) which anchor the hanging hardware 16 and pull the border 14 and central portion 12 taut. Referring to FIG. 2, in one rear projection mode of installation, the screen 10 when installed and taut permits both front and rear projection by a single projector 34 with substantially equal brightness at both front 26 and rear 28 sides of the screen. It is noted that this hardware and manner of hanging the screen 10 does not create any barrier to viewing images projected by a projector 34 on either side of the screen. In addition, according to a preferred aspect of the invention and as a result of the particular fabric construction, a projected image on the central portion diffuses evenly without additional optics (e.g., corrective lenses) providing substantially consistent brightness over a substantially 180° viewing angle on each of the front and rear surfaces of the central portion 12 in a rear projection mode of use. The screen has a measured screen gain of 0.78 (the luminance transmitted by the screen, divided by the luminance radiating from the projector). Given the open mesh construction of the screen, this is considered relatively high.

Referring to FIG. 3, the screen may also readily be attached to a wall structure 36. The wall 36 can include fixed mounts 38 and hooks 22 at the ends of resilient springs or cords 24a extend between the mounting hardware 16 on the screen and the mounts 38 to pull the screen 10 taut. Alternatively, more temporary mounting structures can be used.

In addition, the screen can be constructed in substantially any size, from a relatively small four feet diagonal dimension to over one hundred feet. As the size of the screen increases, the distance of the projector from the screen will also need to be increase, as well as the viewer's distance to maintain resolution. However, resolution can be maintained at larger screen sizes even at larger mesh hole sizes. For example, while a mesh hole of 0.65 mm is preferred for a screen having a central portion of approximately 6.25 ft across its diagonal dimension, a 0.78 mm hole can be used for a screen having a central portion of approximately 7.25 ft diagonal, a 0.91 mm hole can be used for a screen having a central portion of approximately 8.75 ft diagonal, a 1.04 mm hole can be used for a screen having a central portion of approximately 10 ft diagonal, a 1.17 mm hole can be used for a screen having a central portion of approximately 11.66 ft diagonal, a 1.30 mm hole can be used for a screen having a central portion of approximately 12.5 ft diagonal, a 1.43 mm hole can be used for a screen having a central portion of approximately 13.3 ft diagonal, a 1.56 mm hole can be used for a screen having a central portion of approximately 15 ft diagonal, a 3.12 mm hole can be used for a screen having a central portion of approximately 28.3 ft diagonal, a 6.25 mm hole can be used for a screen having a central portion of approximately 58.3 ft diagonal, and a 12.5 mm hole can be used for a screen having a central portion of approximately 116.5 ft diagonal, all while maintaining the same subjective image quality, provided the thread size is proportionately increased, the projector distance from the screen is proportionately increased and the viewer-to-screen distance is also proportionately increased.

There have been described and illustrated herein portable fabric projection screens. While particular embodiments of the invention have been described, it is not intended that the invention be limited thereto, as it is intended that the invention be as broad in scope as the art will allow and that the specification be read likewise. Thus, while it has been described to mount the screen to floor and ceiling or to a wall, it is recognized that the hanging hardware is adapted to suspend the screen from any static structure, whether temporary or permanent, or indoors or outdoors. Furthermore, the screen may be attached to structure that are non-stationary such as lighter than air balloons, watercraft, etc. Also, while the sturdier border about the central portion is preferably fabric, it may be constructed of another type of material, such as a plastic, a film, a metal, etc. In addition, while hanging hardware and associated hooks and suspenders (individually and collectively ‘mounting hardware’) have been disclosed, it is appreciated that other suitable mounting hardware can be used, particularly where the projection screen is intended for more permanent installation. Furthermore, hardware can be provided which permit the screen to be taut even when not attached to another static-type structure. For example, poles can be coupled to the border to stretch to the central portion, with such screen being movable relative to its surroundings. In addition, the open mesh knit fabric can be incorporated into a roller-type screen. It will therefore be appreciated by those skilled in the art that yet other modifications could be made to the provided invention without deviating from its spirit and scope as claimed.

What is claimed is:

1. A projection screen, comprising:
a substantially white fabric central portion for imaging a projected image, said central portion constructed of threads comprising at least two synthetic fibers twisted or wound together, said threads being knit together into an open mesh;
a relatively sturdier border attached about said central portion; and
mounting hardware at spaced apart locations on said border.

2. A projection screen according to claim 1, wherein:
said synthetic fibers are spun polyester in a white color.

3. A projection screen according to claim 1, wherein:
said open mesh has round holes.

4. A projection screen according to claim 3, wherein:
said diameter of each said round hole is approximately 0.65 mm.

5. A projection screen according to claim 3, wherein:
a thread center-center dimension across each hole is approximately 1.23 mm.

6. A projection screen according to claim 1, wherein:
when said central portion is taut and no image is projected thereon, said central portion is substantially transparent.

7. A projection screen according to claim 1, wherein:
said border is constructed of a stretch fabric.

8. A projection screen according to claim 1, wherein:
said border is constructed of a non-stretch fabric.

9. A projection screen according to claim 1, wherein:
said screen is machine washable.

10. A projection screen according to claim 1, wherein:
front and rear sides of said central portion have substantially equal brightness in both front and rear projection modes of projection.

11. A projection screen according to claim 1, wherein:
in a front projected mode, a projected image has substantially consistent brightness over a substantially 180° viewing angle on a front surface of said central portion.

12. A projection screen according to claim 1, wherein:
in a rear projected mode, a projected image has substantially consistent brightness over a substantially 180° viewing angle on a front surface of said central portion.

13. A projection screen according to claim 12, wherein:
the projected image has substantially consistent brightness over a substantially 180° viewing angle on a rear surface of said central portion.

14. A projection screen according to claim 1, wherein:
said fibers are substantially opaque.

15. A projection screen according to claim 1, wherein:
said screen has high diffusion.

16. In a substantially white open mesh knit fabric comprised of threads of two synthetic fibers twisted or wound together, the fabric having threads approximately 0.3 mm in diameter, defining round holes of approximately 0.65 mm diameter, and the thread center-center dimension across a hole is approximately 1.2 mm, the improvement comprising:
a border sturdier than the open mesh knit fabric attached about an entire periphery of said open mesh knit fabric; and
means for holding said open mesh knit fabric taut.

17. A method of providing a projection screen, comprising:
a) providing a fabric constructed of threads comprising at least two synthetic fibers twisted or wound together, and the threads being knit together into an open mesh substantially white in color; and
b) stretching the fabric taut into an image projection screen.

18. A method according to claim 17, wherein:
said providing includes providing the fabric in a polygonal shape, and said stretching includes pulling the fabric at spaced apart locations.

19. A method according to claim 17, further comprising:
prior to stretching the screen taut, folding or crumpling the screen such that wrinkles are provided in the fabric.

20. A method according to claim 17, further comprising:
machine washing the screen.

21. A method according to claim 17, further comprising:
projecting an image on the screen.
